(19) United States
(12) Patent Application Publication
(10) Pub. No.: US 2023/0022029 A1
(43) Pub. Date: Jan. 26, 2023

(54) Three-Dimensional Printing System with Enhanced Flat Field Correction Unit

(71) Applicant: LAYERWISE NV, Leuven (BE)

(72) Inventor: Sam Coeck, Boutersem (BE)

(21) Appl. No.: 17/864,539

(22) Filed: Jul. 14, 2022

Related U.S. Application Data
(60) Provisional application No. 63/223,996, filed on Jul. 21, 2021.

(51) Int. Cl. B22F 10/366; B22F 12/41; B22F 12/49; B33Y 10/00; B33Y 30/00

(52) U.S. Cl. CPC B22F 10/366; B22F 12/41; B22F 12/49; B33Y 10/00; B33Y 30/00

(57) ABSTRACT

A three-dimensional printing system includes a motorized build platform, a material coating module, and a beam generation module. The beam generation module includes a laser beam formation unit, a scan module, and flat field focusing system. The laser beam formation unit includes a laser configured to output a laser beam. The scan module is configured to receive the laser beam and to scan the laser beam over a build plane that is above the motorized build platform. The flat field focusing system is configured to focus the laser beam across the laser beam and includes an input component and an output component. The input component is configured to receive the laser beam from the beam formation unit and to pass the laser beam to the scan module. The output component is configured to receive the laser beam from the scan module and pass the laser beam to the build plane.

This non-provisional patent application claims priority to U.S. Provisional Application Ser. No. 63/223,996, Entitled “Three-Dimensional Printing System with Enhanced Flat Field Correction Unit” by Sam Coeck, filed on Jul. 21, 2021, incorporated herein by reference under the benefit of U.S.C. 119(e).

### FIELD OF THE INVENTION

### Field of the Invention

The present disclosure concerns an apparatus and method for a layer-by-layer fabrication of three dimensional (3D) articles by a laser beam-induced solidification or fusion of layers of material such as polymer powders, metal powders, and photocurable resins. More particularly, the present disclosure concerns optics to improve uniformity of a focus of a radiation beam over a build plane.

### Background

Three dimensional (3D) printing systems are in rapidly increasing use for purposes such as prototyping and manufacturing. Certain 3D printing systems utilize layer-by-layer processes to form 3D articles from various materials which can be metal powders, plastic powders, and photocurable resins. For individual material layers, there is a need to selectively fuse, cure, or solidify portions of the material layer by scanning a radiation beam over an area of the material layer. To provide a consistent resolution and material property, the laser beam should have a consistent focus over the area which is otherwise referred to as a build plane. In practice, scanning a radiation beam over a build plane results in some variation in focus, spot shape, and power distribution which can result in inconsistent results. There is a strong desire for improvement.

### BRIEF DESCRIPTION OF THE FIGURES

FIG. 1 is a schematic diagram of a three-dimensional printing system.

FIG. 2 is a schematic diagram of a beam generation module.

FIG. 3 is a schematic diagram of an output flat field component.

### SUMMARY

In an aspect of the disclosure, a three-dimensional printing system includes a motorized build platform, a material coating module, and a beam generation module. The beam generation module includes a laser beam formation unit, a scan module, and flat field focusing system. The laser beam formation unit includes a laser configured to output a laser beam. The scan module is configured to receive the laser beam and to scan the laser beam over a build plane that is above the motorized build platform. The flat field focusing system is configured to focus the laser beam across the build plane and includes an input component and an output component. The input component is configured to receive the laser beam from the beam formation unit and to pass the laser beam to the scan module. The output component is configured to receive the laser beam from the scan module and pass the laser beam to the build plane.

Division of the flat field focusing system into an input component before the scan module and an output component after the scan module enables an input component of relatively smaller diameter and thinner lenses within the flat field focusing or correcting system as compared to a fully integrated flat field focusing system (that has all components together to receive the beam from the scan module). The flat field focusing system of the present disclosure reduces various optical artifacts including spherical aberration, coma, astigmatism, and focal plane curvature errors over the build plane. A key aspect is to provide a smaller and more consistent laser spot size on the build plane which in turn results in more dimensionally accurate 3D articles. The flat field focusing system of the present disclosure reduces these errors at a much lower cost than scaling up the size of an undivided flat field correcting system.

In one implementation the material coating module is configured to deposit a new layer of powder over the motorized build platform. The build plane is defined on an upper surface of the new layer of powder. The powder can include one or more of a metal, polymer, or ceramic. A metal powder can include a single element metal powder or an alloy. The alloy can include more than one type of metal and/or a metal and a ceramic. For powders containing metal and/or ceramic, the laser beam can have an average power level of at least 100 watts, at least 200 watts, at least 500 watts, or at least 1000 watts. The laser has the effect of fusing and/or melting portions of the powder to consolidate the powder into a generally composite material.

In another implementation, the material coating module is configured to deposit a liquid polymer resin over the motorized build platform. The liquid polymer resin can be photocurable by blue, violet, and/or ultraviolet radiation. The effect of photocuring the resin is to solidify and/or harden the resin.

In yet another implementation, the three-dimensional printing system can include a plurality of such beam generation modules. The plurality of beam generation modules can operate simultaneously.

In a further implementation, the input component of the flat field focusing system includes a diverging lens. The diverging lens can be a bi-concave lens or a plano-concave lens. In a more specific implementation, the input component is a bi-concave lens that has a focal length of −1000 millimeters (mm). A bi-concave lens is a lens with a concave (curved inwards) geometry on each of two opposite sides. A plano-concave lens has a flat side opposite to a concave side.

In a yet further implementation, the output component can include a plurality of lenses. The plurality of lenses can include three lenses including a divergent lens and two convergent lenses. The divergent lens can be plano-concave. The two convergent lenses can individually be plano-convex.

In another implementation, the three-dimensional printing system includes a controller configured to: (a) operate the motorized build platform to vertically position an upper surface of the motorized build platform or build material, (b) operate the material coating module to form a new layer of material over the upper surface, and (c) operate the beam generation module to selectively harden the new layer of material. The controller repeats (a)-(c) to complete manufacture or fabrication of a three-dimensional article.

### DETAILED DESCRIPTION OF THE PREFERRED EMBODIMENTS

FIG. 1 is a schematic diagram of a three-dimensional (3D) printing system 2 for forming a 3D article 4. In describing 3D printing system 2, mutually orthogonal axes X, Y and Z can be used. Axes X and Y are lateral axes that are generally horizontal. Axis Z is a vertical axis that is generally aligned with a gravitational reference. By “generally” it is intended to be so by design but may vary due to manufacturing tolerances or other sources of variation.

The 3D printing system 2 includes a 3D print engine 6 coupled to a controller 8. The controller 8 can include a single computer co-located with the print engine 6 or it can include two or more computers, some of which are physically separated from or even remotely located relative to the print engine 6.

The print engine 6 includes a build container 10 containing a motorized build platform 12. Motorized build platform 12 has an upper surface 14 and a mechanism 15 (details not shown) for precisely vertically positioning build platform 12. The mechanism can include a mechanical drive such as a rack and pinion, lead screw, or other drive system. A lead screw drive system can include a lead screw coupled to a fixed motor. The lead screw can be received into a threaded nut that is coupled to the build platform 12. Under command of the controller 8, the motor can turn the lead screw to vertically position the build platform 12. Motorized systems for vertically moving and positioning build platforms are known in the art of three-dimensional printing.

Print engine 6 includes a material coating module 16 that is configured to form a uniform layer of material 18 such as metal powder over the motorized build platform 12. When a new uniform layer of material 18 is formed, an upper surface 20 of the new uniform layer of material 18 can be referred to as partly defining a “build plane 22”. A material coating module 16 can include a dispenser for dispensing the material 18 and a wiper blade for assuring a planar and uniform surface 20. Motion of the material coating module 16 during dispensing and wiping can be imparted by a motorized lead screw, a motorized belt, or other motorized movement mechanism. The dispenser can include a rotating cylinder for metering out material or a valve for selectively releasing material to name two examples. Coaters for coating liquid or powder materials are known in the art of three-dimensional printing.

The print engine 6 includes a beam generation module 24 which is configured to generate and scan a focused laser beam 26 over a the build plane 22 to selectively harden a new layer of material 18 under control of controller 8. The beam generation module 24 will be described in greater detail with respect to figures that are subsequent to FIG. 1. The beam generation module 24 has a unique optical structure to provide a very uniform and focused power density of a laser beam 26 over the build plane 22. In some embodiments, laser beam 26 can include a plurality of laser beams 26 that can be independently generated and scanned over the build plane 22.

The controller 8 is configured to operate portions of the print engine 6 to manufacture or fabricate the 3D article 4. The controller is configured to: (a) receive a data file defining 3D article 4, (b) process the data file to prepare it for operating print engine 6, (c), operate the motorized build platform 12 to position an upper surface 14 or 20 proximate to build plane 22, (c) operate the material coating module 16 to apply a new layer of build material 18 to the upper surface 14 or 20, (d) operate the beam generation module 24 to selectively harden the new layer of build material 18, and repeat (c)-(d) to complete manufacture or fabrication of article 4.

Controller 8 includes a processor (at least one CPU) coupled to an information storage device (at least one non-transient or non-volatile device). The information storage device stores software modules that individually contain instructions. The information storage device can include one or more of non-volatile or non-transient computer memory, flash memory, and disk drives. The controller 8 is configured to operate various portions of the print engine 6 when the processor executes the instructions.

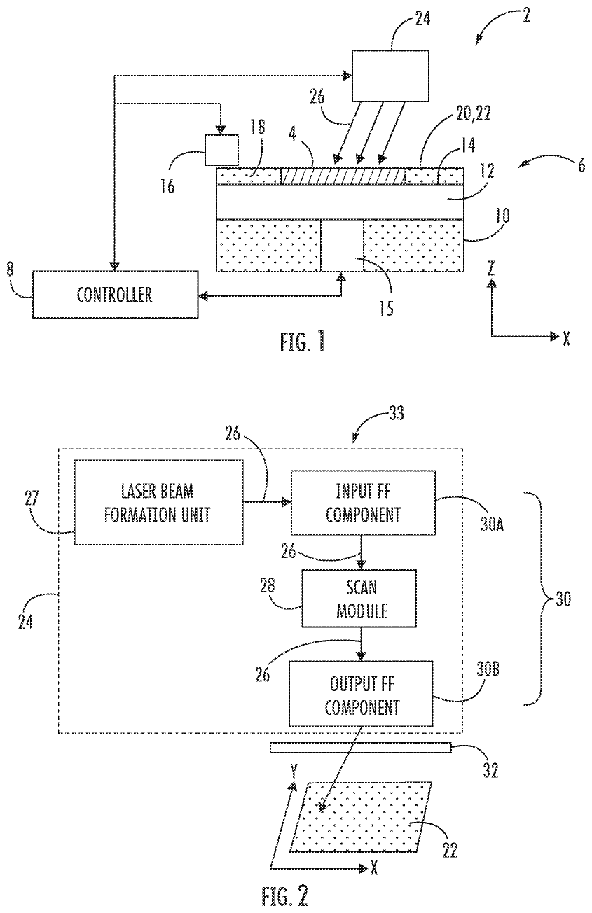

FIG. 2 is a schematic diagram of the beam generation module 24. Beam generation module 24 includes a laser beam formation unit 27, a scan module 28, and a flat field focusing system 30.

The laser beam formation module 27 includes a laser (not shown) and associated optics for forming laser beam 26. The laser beam 26 emitted by the laser beam formation module 24 is collimated which means that the light is accurately parallel. Lasers are well known in the art of three-dimensional printing.

The scan module 28 is configured to reflect the laser beam 26 onto the build plane 22. Also, the scan module 28 is configured to scan the laser beam 26 across the build plane 22 in X and Y. In the illustrated embodiment, the scan module 28 includes a pair of motorized mirrors including an X-mirror and a Y-mirror. The mirrors can be referred to as “galvanometer scanning mirrors”. The laser beam 26 from the laser beam formation module 27 impinges upon the X-mirror, reflects to the Y-mirror, and then down to the build plane 22. Controlled motorized motion of the X-mirror translates the laser beam 26 along the X-axis of build plane 22. Controlled motorized motion of the Y-mirror translates the laser beam 26 along the Y-axis of build plane 22.

The flat field system 30 is an optical system of lenses that is configured to consistently focus the laser beam 26 over the build plane 22 regardless of position in X and Y. The flat field system 30 includes an input flat field component 30A and an output flat field component 30B. The laser beam 26 from the laser beam formation unit 27 passes directly to and through the input flat field component 30A and to the scan module 28. The scan module 28 reflects the laser beam 26 to and through the output flat field component 30B before reaching the build plane 22.

In the illustrated embodiment, a transparent window 32 separates the beam generation module 24 from a region containing the build plane 22. The transparent window 32 protects the beam generation module 24 from fumes generated when the laser beam solidifies (fuses or photocures) material over the build plane 22.

The system illustrated in FIG. 2 can be described in terms of an optical path 33 which is the path that the laser beam 26 takes from the laser beam formation unit 27 to the build plane 22. Along the optical path 33, the input flat field component 30A is before the scan module 28 and the output flat field component 30B is after the scan module 28. The laser beam 26 is output or formed by the laser beam formation unit 27, passes through the input flat field component 30A and to the scan module 28, is reflected and scanned by the scan module 28 to the output flat field component 30B, passes through the output flat field component 30B, passes through the transparent window 32, and then is scanned over the build plane 22.

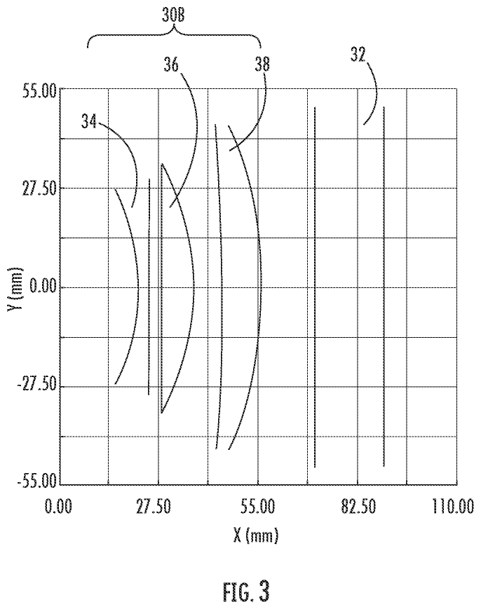

An embodiment of the flat field focusing system 30 is now described. The input flat field component 30A is a single divergent lens. The output flat field component 30B is a set of three lenses. The set of three lenses can include a divergent lens and two converging lenses. Such an embodiment of the output flat field component 30B is illustrated in FIG. 3. FIG. 3 is an optical diagram illustrating a three lens output flat field component 30B and the transparent window 32. The three lens output flat field component 30B includes divergent lens 34, convergent lens 36, and convergent lens 38.

In the illustrated embodiment, the input component 30A is a divergent bi-concave lens with a focal length equal to −1000 millimeters (mm). Divergent lens 34 is a plano-concave lens. Convergent lens 36 is a plano-convex lens. Convergent lens 38 is a plano-convex lens. In operation, light passes (1) from a (1) laser 27 through the (2) plano-concave lens 34 through the (3) scan module 28 through the (4) plano-concave lens 34 through the (5) plano-convex lens 36 through the (6) plano-convex lens 38 through the (7) transparent window 32 and to the (8) build plane 22 over the top surface of a layer of material 18.

The illustrated embodiment has advantages in design. The input flat field component 30A (single divergent lens) can be designed with a relatively small diameter because the laser beam 26 impinging upon it is not scanning. The first converging lens 36 can be closer to the diverging lens 34 and thus can have a smaller diameter. The second converging lens 38 can also be thinner (less curvature) which reduces optical aberration. The result is an improvement in focus over build plane 22 without added size and cost of the optics of the flat field focusing system 30. The result is further an improvement in a focused spot size across the build plane 22. This in turn results in a 3D article 4 that is much more dimensionally accurate.

The first embodiment can have some variants. The input flat field component 30A can be a bi-concave lens. Alternatively the input flat field component 30A can be a plano-concave lens. In a particular illustrative embodiment, the input flat field component 30A can have a focal length of −1000 millimeters but other focal lengths are possible depending on system requirements. In general a selection of particular focal lengths for the lenses 30A/B is a function of various geometries of the optical path 33 and the size of the build plane 22.

The specific embodiments and applications thereof described above are for illustrative purposes only and do not preclude modifications and variations encompassed by the scope of the following claims.

What is claimed:

1. A three-dimensional printing system comprising:
a motorized build platform;
a material coating module;
a beam generation module including:
a laser beam formation unit including a laser configured to output a laser beam;
a scan module for configured to receive the laser beam and scan the laser beam over a build plane that is above the motorized build platform;
a divided flat field focusing system configured to focus the laser beam across the build plane and including:
an input component configured to receive the laser beam from the beam formation unit and to pass the laser beam to the scan module;
an output component configured to receive the laser beam from the scan module and to pass the laser beam to the build plane.

2. The three-dimensional printing system of claim 1 wherein the material coating module is configured to deposit a layer of material over the motorized build platform, the layer of material includes one or more of a liquid material and a powder material.

3. The three-dimensional printing system of claim 2 wherein the layer of material includes one or more of a polymer, a metal, a ceramic, and an alloy.

4. The three-dimensional printing system of claim 3 wherein the layer of material is a powder including one or more of a metal powder, a ceramic powder, and an alloy powder.

5. The three-dimensional printing system of claim 4 wherein the laser beam has a power level of at least 100 watts.

6. The three-dimensional printing system of claim 1 wherein the input component of the flat field focusing system includes a diverging lens.

7. The three-dimensional printing system of claim 6 wherein the diverging lens is a bi-concave lens.

8. The three-dimensional printing system of claim 6 wherein the diverging lens is a plano-concave lens.

9. The three-dimensional printing system of claim 1 wherein the output component of the flat field focusing system includes a series of at least three lenses.

10. The three-dimensional printing system of claim 9 wherein the series of at least three lenses includes one divergent lens and two convergent lenses.

11. The three-dimensional printing system of claim 1 further comprising a controller configured to:
operate the motorized build platform to vertically position an upper surface of the motorized build platform or build material;
operate the material coating module to form a new layer of material over the upper surface; and
operate the beam generation module to selectively harden the new layer of material.

12. A method of manufacturing a three-dimensional article comprising:
providing a three-dimensional printing system including:
a motorized build platform;
a material coating module;
a beam generation module including:
a laser beam formation unit including a laser configured to output a laser beam;
a scan module for configured to receive the laser beam and scan the laser beam over a build plane that is above the motorized build platform;
a divided flat field focusing system configured to focus the laser beam across the build plane and including:
an input component configured to receive the laser beam from the beam formation unit and to pass the laser beam to the scan module;
an output component configured to receive the laser beam from the scan module and to pass the laser beam to the build plane; and
operating the three-dimensional printing system to fabricate the three-dimensional article.

13. The method of claim 12 wherein operating the three-dimensional printing system includes operating the material coating module to deposit a layer of material over the motorized build platform, the layer of material includes one or more of a liquid material and a powder material.

14. The method of claim 13 wherein the layer of material includes one or more of a polymer, a metal, a ceramic, and an alloy.

15. The method of claim 14 wherein the layer of material is a powder including one or more of a metal powder, a ceramic powder, and an alloy powder.

16. The method of claim 15 wherein operating the three-dimensional printing system includes operating the laser beam to output a power level of at least 100 watts.

17. The method of claim 12 wherein the input component of the flat field focusing system includes a diverging lens and wherein operating the three-dimensional printing system includes passing the laser beam from the laser to the diverging lens and then to the scan module.

18. The method of claim 17 wherein the output component of the flat field focusing system includes a series of at least three lenses and wherein operating the three-dimensional printing system includes passing the laser beam from the scan module to the series of at least three lenses.

19. The method of claim 18 wherein the series of at least three lenses includes a second diverging lens, a first converging lens, and a second converging lens and wherein operating the three-dimensional printing system includes (1) passing the laser beam from the scan module through the second diverging lens, then (2) passing the laser beam through the first converging lens, and then (3) passing the laser beam through the second converging lens.

20. The method of claim 19 wherein operating the three-dimensional printing system includes passing the laser beam from the second converging lens to a build plane.
